(19) United States
(12) Patent Application Publication
(10) Pub. No.: US 2007/0087214 A1
(43) Pub. Date: Apr. 19, 2007

(54) Methods for stretch blow molding polymeric articles

(76) Inventors: Robert Charles Portnoy, Houston, TX (US); Wen Li, Houston, TX (US); Ivana Jovanovic, Boston, MA (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/522,725

(22) Filed: Sep. 18, 2006

Related U.S. Application Data
(60) Provisional application No. 60/726,763, filed on Oct. 14, 2005.

(51) Int. Cl. B29C 49/00; B29B 7/00

(52) U.S. Cl. 428/542.8; 264/523; 264/537

(57) ABSTRACT

Methods for making stretch blow molded polypropylene articles and preforms used to produce the polypropylene stretch blow molded articles are provided. In certain embodiments, the articles are produced with stretch blow molding processes using composite stretch ratios of less than or equal to 6. The blow molded articles may be bottles. In certain embodiments, the preforms for producing the blow molded articles have a maximum axial dimension that is at least 35% of the axial dimension of the blow molded article and a maximum radial dimension that is at least 35% of the maximum radial dimension of the blow molded article.

### CROSS REFERENCE TO RELATED APPLICATIONS

This application claims the benefit of Provisional Patent Application No. 60/726,763, filed Oct. 14, 2005, the disclosure of which is incorporated by reference.

### FIELD OF THE DISCLOSURE

This disclosure relates to methods for stretch blow molding polymeric articles, particularly bottles, and the molding preforms used therein.

### BACKGROUND INFORMATION

Although processes for stretch blow molding of articles, especially bottles, from polymeric materials including polypropylene have been known for many years, the processes are not entirely satisfactory. In some instances articles formed from polypropylene require a high degree of structural rigidity that is difficult to achieve. Additionally, for such articles to be economically manufactured, the fabrication mode must be capable of producing the article at a desired minimum rate, also referred to as “cycle time”. The cycle time for injection molding may generally be described as the duration from the introduction of molten polymer into the mold to the release of the molded article from the mold. The cycle time is in part function of the viscosity of the molten polymer. Cycle time also relates to the crystallization temperature of the polymer. Generally, the crystallization temperature is the pivotal temperature at which the molten liquid polymer hardens. This hardening is due, in part, to the formation of crystalline structures within the polymer. It follows that as the molten polymer cools in the mold, molten polymers having higher crystallization temperatures will form crystalline structures sooner than polymers having lower crystallization temperatures. As such, shorter cycle times may be achieved by using polymers with higher crystallization temperatures. It will be understood from this that many variables are relevant and require consideration before selecting a polymer for a particular application.

Stretch blow molding methods generally include a first stage during which a preform is injection molded. An article is obtained by stretch blow molding of this preform. The article may be manufactured in a one stage technique, also known as a “hot cycle” technique, by linking the production of the hot preform with blow molding of an article from the preform before the preform cools. Another method for producing blow molded articles involves a two-stage technique also known as “cold cycle” in which the preform is allowed to cool and later the preform is heated and blow molded to form the article.

In the cold cycle technique, the preform is reheated as evenly as possible throughout its thickness. In the hot cycle technique, the preform is cooled to a temperature immediately below its melting point. In both processes, the preform is then subjected to axial and radial stretching to form the blow molded article. In conventional processes, a polypropylene preform is typically stretched at composite ratios of 10 to 14.

Composite stretch ratios are determined by multiplying the stretch in the longitudinal dimension times the stretch in the radial dimension. For example, if a preform is blown into a container, it may be stretched two times its axial dimension and stretched six times its radial dimension resulting in a composite stretch ratio of 12, calculated by multiplying 2 times 6. Of course, in certain processes, the preform may be stretched more than once in a given dimension. For example a preform may be stretched in the axial dimension followed by stretching in both the radial dimension and again in the axial dimension. In such processes, the composite stretch ratio is calculated by multiplying the total axial and the total radial stretch ratios.

A large volume of patent literature related to blow molding of polymeric articles exists. The following patents provide additional detail regarding blow molding processes: U.S. Pat. Nos. 4,357,288, 5,242,066, 5,364,585, 6,733,716, 6,749,911, U.S. publication 20040162842, U.S. publication 20050173844, U.S. publication 20050161866, U.S. publication 20040099997, and U.S. Pat. 6,258313.

### SUMMARY OF THE DISCLOSURE

The disclosure relates to methods for producing stretch blow molded polypropylene articles and preforms used for producing polymeric stretch blow molded articles. In certain embodiments, the articles are produced in stretch blow molding processes using composite stretch ratios of less than or equal to 6.

In certain embodiments, the blow molded article is a bottle. In other embodiments, this disclosure relates to preforms for producing blow molded articles. The preforms have a maximum axial dimension that is at least 35% of the maximum axial dimension of the blow molded article and a maximum radial dimension that is at least 35% of the maximum radial dimension of the blow molded article.

### BRIEF DESCRIPTION OF THE DRAWINGS

FIG. 1 is a cross sectional view of an exemplary bottle preform in accordance with the methods described herein.

FIG. 2 is side elevation view and a top view of an exemplary bottle produced in accordance with the methods described herein.

FIG. 3 is graph showing stiffness/impact balance of exemplary bottles produced according to the methods described herein.

### DETAILED DESCRIPTION

This disclosure relates to methods for producing blow molded polymeric articles and preforms used to produce the polymeric articles. The blow molded articles formed by the methods disclosed herein exhibit beneficial impact strength and clarity properties. The methods and preforms described herein are particularly useful for producing articles produced from propylene-based polymeric materials.

In certain embodiments, this disclosure relates to processes and preforms for producing polypropylene bottles and other articles of good clarity, stiffness and impact resistance. The articles may be produced from preforms having thinner walls that are stretched at specific stretch ratios as described in more detail hereinafter. In some embodiments, the stretch ratio components may be balanced between the axial and radial components. The thinner walled preforms cool more rapidly than conventional polypropylene preforms and can also be reheated at a rate that allows stretch blow molding at favorable machine speeds.

In stretch blow molding process techniques, orientation of a preform reduces the dimensions of the crystalline structure of the polymeric material of the preform. Orientation of the crystalline structure through high stretch ratios is generally thought necessary to achieve good optical properties for blow molded polypropylene articles. Generally, special attention must be paid to controlling the stretching temperature to obtain a desired mix of solid and molten polymer due to partial melting of the polymer crystals.

Both the one-step and two-step processes for producing propylene articles have not been fully economically competitive with the stretch blow molding of polyethylene terephthalate (PET). Generally the disadvantages associated with polypropylene arise from slower hardening upon cooling and poorer absorption of heat during reheating of product preforms of polypropylene, as compared to PET. In the one-step process, the limited output of polypropylene articles, because of slower hardening, makes the process less economically attractive than a one-step process for PET articles. In the higher speed two-step process, the slow hardening of thick polypropylene preforms during the injection molding and the slow reheating of them during stretch blow molding makes the use of polypropylene cost prohibitive compared to PET. The lower density of polypropylene generally requires thicker preforms and bottle walls than for equal weights of PET. Composite stretch ratios of 10 to 14 have been thought to be required for biaxially oriented polypropylene to exhibit clarity, stiffness and impact resistance properties similar to PET.

Generally, in accordance with the methods and preforms described herein, the walls of the polypropylene preforms are thinner, as compared to conventional polypropylene preforms. In certain embodiments of the methods and preforms described herein, the preform generally has a maximum wall thickness of 3 mm or less. In other embodiments, the preforms have a maximum wall thickness of 2.78 mm or less. In still other embodiments, the preforms have a maximum wall thickness of 2.5 mm or less.

The use of preforms having thinner walls offers various advantages. For example, the resulting blow molded articles, including bottles, have favorable price/properties ratios, good mechanical properties and high transparencies. Bottles produced in accordance with the methods described herein are particularly suitable for packaging of beverages, detergents, cosmetics, medicaments, and foodstuffs and the like.

In certain embodiments, the methods described herein include stretching preforms at composite stretch ratios of about less than or equal to 6. In other embodiments, the methods described herein include stretching preforms at composite stretch ratios of about 4 to about 6. In still other embodiments, the methods described herein include stretching preforms at stretch ratios of about 5 to about 6. Composite stretch ratios are determined by multiplying the axial dimension stretch of a preform by the radial dimension stretch of the preform.

In certain embodiments, the composite stretch ratios are produced by stretching the preforms from about 2 to about 3 times in both the axial dimension and the radial dimension. In other embodiments, the composite stretch ratios are produced by stretching the preforms from about 2.4 to about 3 times in both the axial dimension and the radial dimension.

In certain embodiments, the composite stretch ratios are generally balanced between the axial and radial components. In particular embodiments, the preforms are stretched about 2.4 times in both the axial dimension and the radial dimension to produce composite stretch ratios of less than 6. In other embodiments, preforms are stretched about 2 times in the axial dimension and about 2 times in the radial dimension to produce composite stretch ratios of less than 4.5. In other embodiments, preforms comprising or consisting essentially of polypropylene are stretched about 1.75 times in the axial dimension and about 1.75 times in the radial dimension to produce composite stretch ratios of less than 3.5.

Of course, in certain embodiments, the composite ratios described here are provided by unbalanced stretching in the axial and radial dimensions.

In certain embodiments, the preforms have a maximum axial dimension that is at least 35% of the maximum axial dimension of the blow molded article produced from the preform and a maximum radial dimension that is at least 35% of the maximum radial dimension of the blow molded article produced from the preform. In other embodiments, the preforms have a maximum axial dimension that is at least 35% of the maximum axial dimension of the blow molded article produced from the preform and a maximum radial dimension that is at least 40% of the maximum radial dimension of the blow molded article produced from the preform. In still other embodiments, the preforms have a maximum axial dimension that is at least 35% of the maximum axial dimension of the blow molded article produced from the preform and a maximum radial dimension that is at least 45% of the maximum radial dimension of the blow molded article produced from the preform.

The preforms described herein may be produced at rates faster than PET preforms of comparable weights and designs. The methods described herein provide polypropylene articles with excellent clarity, stiffness, impact strength, taste, and odor properties, at rates faster than conventional polypropylene stretch blow molding processes. In certain embodiments, polypropylene bottles may be produced by the methods described herein at rates faster than conventional processes.

As used herein, “complete cycle time” for injection molding refers to the duration from the onset of the introduction of molten polymer into a mold for the production of one article or set of articles to the introduction of molten polymer into a mold for the production of the next article or set. More broadly, it is the time elapsed between the same instance in any two successive molding cycles. Complete cycle times for preparation of preforms according to the present invention are preferably 20 seconds or less, more preferably 18 seconds or less, more preferably 15 seconds or less, more preferably 13 seconds or less, more preferably 12 seconds or less, and even more preferably 10 seconds or less. Complete cycle times for preparation of finished articles from preforms according to the present invention are preferably 20 seconds or less, more preferably 18 seconds or less, more preferably 15 seconds or less, more preferably 13 seconds or less, more preferably 12 seconds or less, and even more preferably 10 seconds or less.

As used herein, the terms “polypropylene” and “polypropylene”, and “propylene-based” refer to polymeric materials having a polypropylene content of at least 60 wt. %. The polypropylene may be a polypropylene homopolymer or copolymer incorporating at least 90 wt. % propylene units, and blends thereof. For purposes of this disclosure the term “copolymer” means a polymer incorporating two or more different monomer units. The polypropylene copolymer may be a random copolymer or a crystalline/semi-crystalline copolymer, such as polypropylene with either isotactic or syndiotactic regularity. In certain embodiments, the polypropylene is a random copolymer. In certain embodiments, the polymeric materials have a polypropylene content of at least 90 wt. %.

Comonomers that are useful in general for producing the polypropylene copolymers include alpha-olefins, such as C₂ and C₄-C₂₀ olefins. Examples of olefins include, but are not limited to, ethylene, 1-butene, 1-hexene, 1-pentene, 1-octene, and 4-methyl-1-pentene. In certain embodiments, the olefin is ethylene. In certain embodiments, the olefin content is less than 8 wt. %. In additional embodiments, the olefin content is about 3 wt. % or less. In other embodiments, the olefin content is from about 1 wt. % to about 3 wt. %. A polypropylene having a certain melt flow rate may be selected depending on the type of processing method utilized.

The polypropylene may be produced using any conventional polymerization process, such as a solution, a slurry, or a gas-phase process, with any suitable catalyst, such as a Ziegler-Natta catalyst or a metallocene catalyst with any suitable reactor system, such as a single or a multiple reactor system.

In certain embodiments, the polypropylene is a metallocene catalyzed polypropylene homopolymer or random copolymer incorporating from about 1 wt. % to about 3 wt. % of units derived from ethylene. Block copolymers and impact copolymers may also be used.

Although the polypropylene compositions have generally been referred to as single polymer compositions, blends of two or more such polypropylene polymers having the properties described herein are also contemplated for use in the methods and preforms described herein.

As used herein “metallocene” and “metallocene component” refer generally to compounds represented by the formula Cpm MRn Xq wherein Cp is a cyclopentadienyl ring which may be substituted, or derivative thereof which may be substituted, M is a Group 4, 5, or 6 transition metal, for example titanium, zirconium, hafnium, vanadium, niobium, tantalum, chromium, molybdenum and tungsten, R is a hydrocarbyl group or hydrocarboxy group having from one to 20 carbon atoms, X is a halogen, and m=1-3, n=0-3, q=0-3, and the sum of m+n+q is equal to the oxidation state of the transition metal.

Methods for making and using metallocenes are well known in the art. For example, metallocenes are detailed in U.S. Pat. Nos. 4,530,914; 4,542,199; 4,769,910; 4,808,561; 4,871,705; 4,933,403; 4,937,299; 5,017,714; 5,026,798; 5,057,475; 5,120,867; 5,278,119; 5,304,614; 5,324,800; 5,350,723; and 5,391,790.

Methods for preparing metallocenes are fully described in the Journal of Organometallic Chem., volume 288, (1985), pages 63-67, and in EP-A-320762, both of which are herein fully incorporated by reference.

Metallocene catalyst components are described in detail in U.S. Pat. Nos. 5,145,819; 5,243,001; 5,239,022; 5,329,033; 5,296,434; 5,276,208; 5,672,668; 5,304,614; 5,374,752; 5,240,217; 5,510,502 and 5,643,847; and EP 549,900 and EP 576,970.

Exemplary, but non-limiting examples of, desirable metallocenes include: Dimethylsilanylbis(2-methyl-4-phenyl-1 -indenyl)ZrCl2; Dimethylsilanylbis(2-methyl-4,6-diisopropylindenyl)ZrCl2; Dimethylsilanylbis(2-ethyl-4-phenyl-1 -indenyl)ZrCl2; Dimethylsilanylbis(2-ethyl-4-naphthyl-1 -indenyl)ZrCl2, Phenyl(Methyl)silanylbis(2-methyl-4-phenyl-1 -indenyl)ZrCl2, Dimethylsilanylbis(2-methyl-4-(1-naphthyl)-1-indenyl)ZrCl2, Dimethylsilanylbis(2-methyl-4-(2-naphthyl)-1-indenyl)ZrCl2, Dimethylsilanylbis(2-methyl-indenyl)ZrCl2, Dimethylsilanylbis(2-methyl-4,5-diisopropyl-1-indenyl)ZrC12, Dimethylsilanylbis(2,4,6-trimethyl-1-indenyl)ZrCl2, Phenyl(Methyl)silanylbis(2-methyl-4,6-diisopropyl-1-indenyl)ZrCl2, 1,2-Ethandiylbis(2-methyl-4,6-diisopropyl-1-indenyl)ZrCl2, 1,2-Butandiylbis(2-methyl4,6-diisopropyl-1-indenyl)ZrC12, Dimethylsilanylbis(2-methyl-4-ethyl-1-indenyl)ZrC12, Dimethylsilanylbis(2-methyl-4-isopropyl-1-indenyl)ZrCl2, Dimethylsilanylbis(2-methyl4-t-butyl-1-indenyl)ZrCl2, Phenyl(Methyl)silanylbis(2-methyl-4-isopropyl-1-indenyl)ZrCl2, Dimethylsilanylbis(2-ethyl-4-methyl-1-indenyl)ZrCI2, Dimethylsilanylbis(2,4-dimethyl-1-indenyl)ZrCl2, Dimethylsilanylbis(2-methyl-4-ethyl-1-indenyl)ZrCl2, and Dimethylsilanylbis(2-methyl-1-indenyl)ZrCl2.

Metallocenes are generally used in combination with some form of activator. Alkylalumoxanes may be used as activators, most desirably methylalumoxane (MAO). There are a variety of methods for preparing alumoxane, non-limiting examples of which are described in U.S. Pat. Nos. 4,665,208; 4,952,540; 5,091,352; 5,206,199; 5,204,419; 4,874,734; 4,924,018; 4,908,463; 4,968,827; 5,308,815; 5,329,032; 5,248,801; 5,235,081; 5,103,031; and EP-A-0 561 476; EP-B1-0 279 586; EP-A-0 594-218; and WO94/10180. Activators may also include those comprising or capable of forming non-coordinating anions along with catalytically active metallocene cations. Compounds or complexes of fluoro aryl-substituted boron and aluminum are suitable. See, for example, U.S. Pat. Nos.5,198,401; 5,278,119; and 5,643,847.

The metallocene catalyst compositions may optionally be supported using a porous particulate material, such as for example, clay, talc, inorganic oxides, inorganic chlorides and resinous materials such as polyolefin or polymeric compounds. The support materials may be porous inorganic oxide materials, which include those from the Periodic Table of Elements of Groups 2, 3, 4, 5, 13 or 14 metal oxides. Silica, alumina, silica-alumina, and mixtures thereof are particularly desirable. Other inorganic oxides that may be employed either alone or in combination with the silica, alumina or silica-alumina are magnesia, titania, zirconia, and the like.

### EXPERIMENTAL EVALUATIONS

### EXAMPLE 1

Preforms for stretch blow molding bottles were injection molded using a Ziegler-Natta catalyzed polypropylene composition with the following characteristics. The base polypropylene was a propylene/ethylene copolymer prepared by polymerizing neat condensed liquid propylene and sufficient ethylene to incorporate 3% by weight of the ethylene units in the copolymer. The polymerization process was carried out in two series, stirred-tank reactors using a fourth generation Ziegler-Natta (Z-N) catalyst system supported on co-precipitated magnesium chloride and titanium tetrachloride and a silane donor. The catalyst was subjected to batch prepolymerization. The molecular weight of the polymer was adjusted during polymerization to provide material with an MFR of 30 g/10 min and a polydispersity index (Mw/Mn) of 3.0 to 3.5. The crude granular polypropylene material was subjected to a washing process to remove catalyst residues and atactic polymer.

The ethylene base copolymer was blended on a weight/weight basis with 0.08% of calcium stearate, 0.06% of Ethanox 330, 0.05% of Irgafos 168, and 0.25% of Millad 3988. The blend was melt compounded and extruded under minimum molecular weight breakdown conditions, yielding pellets of the finished product with a 30 g/10 min MFR.

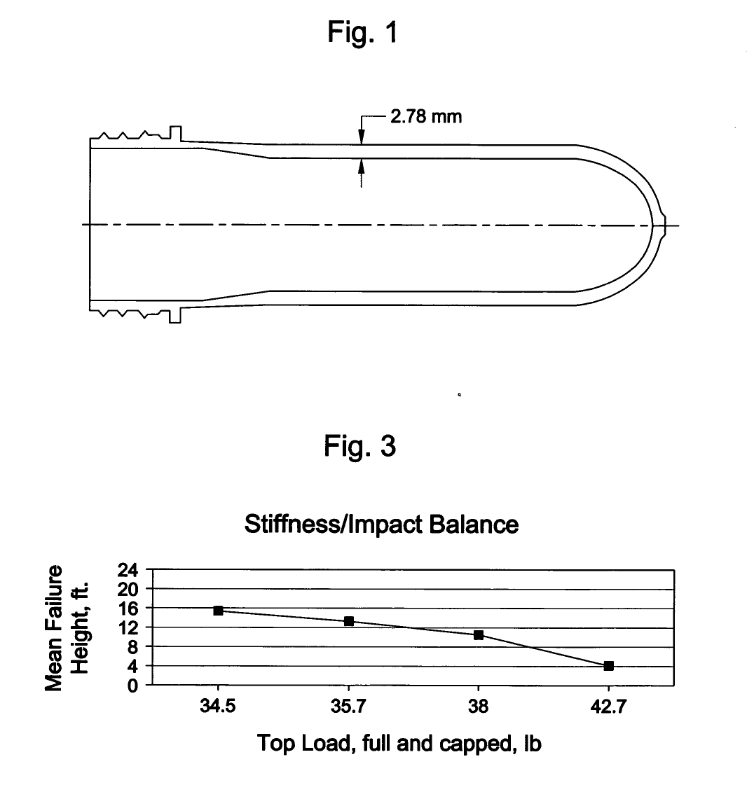

The finished polymer product was converted into preforms by injection molding. The preform dimensions are shown in FIG. 1. The preforms had a standard 38 mm neck finish, with outside diameters of about 32 mm and a total length of about 113 mm with a straight wall section 2.78 mm thick. The preforms weighed 25 g. Using barrel temperatures rising to about 221° C. near the nozzle and mold water temperatures of approximately 26.6° C. the preforms were molded in complete cycle times of about 12 seconds.

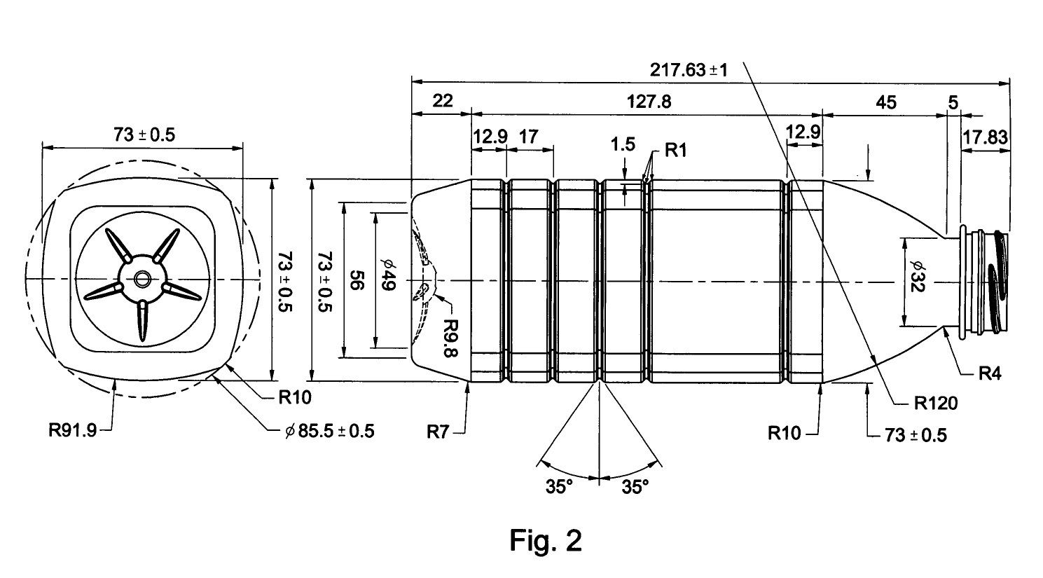

The preforms produced in this manner were stretch blow molded to produce bottles with the dimensions depicted in FIG. 2. An external preform skin temperature of about 130° C. was used as the temperature at which to commence stretch blow molding. The heating elements of the stretch blow molding machine were adjusted to allow surface heat to soak well into the structure. This provided a shallow temperature gradient throughout the preform wall and made it possible to operate the stretch blowing process at 1,200 bottles/cavity/hour, the maximum rate available with the machine used in the evaluation. Properties of the bottles produced are reported in Table I.

TABLE I
(TEST METHODS)

| Property | Value | |
|---|---|---|
| Top load strength, lb/in (kg/2.54 cm) | 20.6 | (9.3) |
| Drop impact strength at RT, mean failure | 23.5 | (7.16 m) |
| height, ft (meters) | | |
| Drop impact strength at 4.4° C., mean failure | 11.3 | (3.4) |
| height, ft (meters) | | |
| Internal haze % | 0.63 | |

### EXAMPLES 2-5

Preforms for stretch blow molding of bottles were injection molded from metallocene-catalyzed polypropylene compositions with the following characteristics. The base polymers used to prepare preform compositions were propylene homopolymers and propylene/ethylene copolymers polymerized from neat condensed liquid propylene and sufficient ethylene to incorporate between 0% and 2% by weight of ethylene units in the base polymer. The processes were carried out in two series stirred-tank reactors using suitable metallocene catalyst. The molecular weights of the base polymers were adjusted to provide material with an MFR of 17 g/10 min and a polydispersity index (Mw/Mn) of 2. The crude, granular polypropylene was subjected to a washing process to the remove catalyst residues and atactic polymer. A blend of 0.33 wt. % the propylene homopolymer and 0.67 wt. % of the 1.5% ethylene by weight copolymer was prepared to simulate a 1.0% ethylene copolymer for use in Example 2. Copolymers containing 1.5% and 2.0% of comonomer units were produced for Examples 3 and 4 respectively. Another sample of the Z-N copolymer composition produced in Example 1 was used for Example 5.

The three base copolymers (1.0, 1.5 and 2.0% ethylene) were blended on a weight/weight basis with 0.08% of calcium stearate, 0.06% of Ethanox 330, 0.05% of Irgafos 168, and 0.25% of Millad 3988. The blends were melt compounded and extruded under minimum molecular weight breakdown conditions, yielding pellets of the finished products all with approximately 18 g/10 min MFR.

The polymer compositions of Examples 2-5 were converted into preforms by injection molding. The same preform dimensions and the same molding conditions were employed as in Example 1 and depicted in FIG. 1.

The preforms produced in this manner were stretch blow molded as in Example 1 to produce bottles having the dimensions depicted in FIG. 2. With increasing ethylene content within the category of metallocene-catalyzed copolymers it was necessary to decrease preform skin temperatures to stretch blow mold good bottles at the maximum machine rate. The range of skin temperatures was approximately from 122° C. to 132° C. Properties of the bottles produced in Examples 2-5 are reported in Table II.

TABLE II

| | Base Polymer Ethylene Content | | | |
|---|---|---|---|---|
| | | | | Ex. 5 |
| | Ex. 2 | Ex. 3 | Ex. 4 | 3.0% |
| | 1.0% | 1.5% | 2.0% | (Z-N) |
| Top load strength | 42.7 | 38.0 | 35.7 | 34.5 |
| (filled and capped), | (19.37) | (17.2) | (16.2) | (15.65) |
| lb/in (kg/ 2.54 cm) | | | | |
| Top load strength | 32.7 | 26.6 | 26.7 | 29.8 |
| (empty), lb/in (kg/2.54 | (14.83) | (12.1) | (12.1) | (13.52) |
| cm) | | | | |
| Drop impact strength | 4.25 | 10.64 | 13.25 | 15.46 |
| at 4.4° C., mean | (1.3) | (3.2) | (4.0) | (4.7) |
| failure height, ft. | | | | |
| (meters) | | | | |
| Total haze (normalized | 1.73 | 2.19 | 1.79 | 1.81 |
| to 0.05 cm wall | | | | |
| thickness), % | | | | |

FIG. 3 is graph demonstrating the stiffness/impact properties balance of the bottles prepared in Example 1.

With respect to organoleptic properties of the exemplary polypropylene bottles prepared, it was observed that water stored in the polypropylene bottles produced as described herein was virtually tasteless. Therefore, the organoleptic properties of polypropylene bottles are equal or better than the organoleptic properties of conventional PET bottles. The organoleptic features of polypropylene bottles produced by the methods described herein are measured by taste intensity. In certain embodiments, the taste intensity of water from bottles produced as described herein is in the range of from about 0 to about 0.5.

Complete cycle times for polypropylene preforms prepared in accordance with the methods described herein are also favorable and competitive with PET preforms produced by conventional methods. As described above, Free Drop complete cycle times of 12 seconds were used. EOAT method complete cycle times of 13.8 seconds are also found to be useful.

In certain embodiments, bottles produced using the methods described herein have capped and filled top load strengths in the range of about 15 lb./inch (6.8 kg/2.54 cm) to about 45 lb./inch (20.4 kg/2.54 cm). In other embodiments, polypropylene bottles produced using the methods described herein have top load strengths of about 20 lb./inch (9.1 kg/2.54 cm) to about 45 lb./inch (20.4 kg/2.54 cm). In additional embodiments, polypropylene bottles produced using the methods described herein have top load strengths of about 30 lb./inch (13.6 kg/2.54 cm) to about 40 lb./inch (18.1 kg/2.54 cm).

In certain embodiments, bottles produced using the methods described herein have cold drop impact strengths, measured by mean failure height at 4.4° C., in the range of from about 10 feet (3.05 m) to about 20 feet (6.1 m). In other embodiments, bottles produced using the methods described herein have cold drop impact strengths, measured by mean failure height at 4.4 ° C. in the range of from about 12 feet (3.7 m) to about 16 feet (4.8 m). In additional embodiments, bottles produced using the methods described herein have cold drop impact strengths , measured by mean failure height at 4.4° C. in the range of from about 16 feet (4.8 m).

Haze may be measured in terms of both total haze and internal haze. In certain embodiments, bottles produced according to the methods described herein have a total haze values in the range of from about 1.5% to about 2%. In other embodiments, bottles produced according to the methods described herein have a total haze values in the range of from about 1.73% to about 1.81%. In still other embodiments, bottles produced according to the methods described herein have a total haze values in the range of from about 1.7% to about 1.8%.

In certain embodiments, the internal haze of bottles produced by the methods described herein is in the range of from about 0.5% to about 0.8%. In other embodiments, the internal haze of bottles produced by the methods described herein is in the range of from about 0.6% to about 0.7%. In additional embodiments, the internal haze of bottles produced by the methods described herein is in the range of less than 0.65%.

With respect to the various ranges set forth herein, any upper limit recited may, of course, be combined with any lower limit for selected sub-ranges.

All patents and publications, including priority documents and testing procedures, referred to herein are hereby incorporated by reference in their entireties.

Although the present invention and its advantages have been described in detail, it should be understood that various changes, substitutions, and alterations could be made without departing from the spirit and scope of the invention as defined by the following claims.

We claim:

1. A method for making a molded article comprising stretch blow molding a preform comprising at least 60 wt. % polypropylene at a composite stretch ratio of less than or equal to 6.

2. The method of claim 1 wherein the preform has a maximum wall thickness of about 3.0 mm or less.

3. The method of claim 2 wherein the molded article is a bottle.

4. The method of claim 3 wherein the preform has a maximum wall thickness of about 2.78 mm or less.

5. The method of claim 4 wherein the composite stretch ratio is from about 5 to about 6.

6. The method of claim 4 wherein the preform and the bottle have an axial dimension and a radial dimension and wherein the preform has a maximum axial dimension that is at least 35% of the maximum axial dimension of the bottle and the preform has a maximum radial dimension that is at least 35% of the maximum radial dimension of the bottle.

7. The method of claim 6 wherein the preform is stretched in the range of from about 2 to about 3 times in both the axial dimension and the radial dimension.

8. The method of claim 7 comprising the step of producing the preform by injection molding.

9. The method of claim 8 wherein the polypropylene is selected form the group consisting of propylene homopolymers, propylene and alpha-olefin copolymers, and blends thereof.

10. The method of claim 9 wherein the bottle has a cold drop impact strength determined at 4.4 ° C. by mean failure height of about 10 feet to about 20 feet.

11. The method of claim 10 wherein the bottle has a filled and capped top load strength measured of about 15 lb/in to about 45 lb/in.

12. The method of claim 11 wherein the polypropylene is selected from copolymers of propylene and ethylene.

13. The method of claim 12 wherein the copolymers of propylene and ethylene comprise about 3 wt. % or less of units derived from ethylene.

14. The method of claim 13 wherein the copolymers of propylene and ethylene comprise from about 1 wt. % to about 3 wt. % of units derived from ethylene.

15. The method of claim 14 wherein the polypropylene is a random propylene copolymer comprising about 1 wt. % to about 3 wt. % of units derived from ethylene and wherein the copolymer is produced in a polymerization process catalyzed by a metallocene catalyst.

16. The method of claim 15 wherein the preform is stretched in the range of from about 2.4 to about 3 times in both the axial dimension and the radial dimension.

17. The method of claim 16 wherein the preform is stretched about 2.4 times in both the axial dimension and the radial dimension.

18. The method of claim 17 wherein the bottle has a total haze value of about 1.5% to about 2%.

19. The method of claim 18 wherein the bottle has an internal haze value of about 0.6% to about 0.7%.

20. A preform for producing a stretch blow molded bottle having an axial dimension and a radial dimension wherein the preform comprises at least 60 wt. % polypropylene and wherein the preform has a maximum axial dimension that is at least 35% of the maximum axial dimension of the blow molded bottle and a maximum radial dimension that is at least 35% of the maximum radial dimension of the stretch blow molded bottle.
